(19) United States
(12) Patent Application Publication
(10) Pub. No.: US 2010/0097464 A1
(43) Pub. Date: Apr. 22, 2010

(54) NETWORK VIDEO SURVEILLANCE SYSTEM AND RECORDER

(75) Inventor: Christopher Volpe, Seekonk, MA (US)

Correspondence Address: LAW OFFICE OF DELIO & PETERSON, LLC., 121 WHITNEY AVENUE, 3RD FLLOR, NEW HAVEN, CT, 06510, US

(73) Assignee: VOLPE INDUSTRIES, Seekonk, MA (US)

(21) Appl. No.: 12/578,704

(22) Filed: Oct. 14, 2009

Related U.S. Application Data
(60) Provisional application No. 61/106,297, filed on Oct. 17, 2008.

(51) Int. Cl. H04N 7/18

(52) U.S. Cl. 348/143; 348/E07.085

(57) ABSTRACT

A video surveillance method and system controls and distributes video signals from multiple surveillance cameras to multiple video clients by receiving a single original video signal stream from a camera and simultaneously converting it a plurality of video streams, with each video stream having a different video quality parameter. The different quality parameters may be different resolutions, degrees of compression, different frame rates, presence or absence of colors, intensity of colors, different contrast levels and different brightness levels. The video clients are entitled to access specified video quality parameters, and are simultaneously sent the converted video streams with the different video quality parameter to which they are entitled to access.

### BACKGROUND OF THE INVENTION

1. Field of the Invention

This invention relates to a video surveillance system recorder, and a method of controlling and distributing live or recorded video signals from video surveillance cameras to multiple video clients.

2. Description of Related Art

Typical surveillance cameras have the ability to send out video signals with different video coding formats or compression type, for example, MPEG-1, -2, and the like, MJPEG, and H.264. Some cameras have the ability to send out different video coding formats or compression types simultaneously. When sending out one or more of such video coding formats or compression type signals, the bandwidth capacity or available bandwidth of the communication path between the camera and video recorder or display unit at the end user is an important consideration. Bit rate transmission and channel capacity may determine which and how many of the different video coding formats or compression types can be sent out from the camera.

At one extreme, remote video cameras may transmit the video signals by wireless radio frequency signals to the end user at relatively low information rates, so that other transmitted video quality parameters become important considerations. Such video quality parameters include the presence or absence of color in the screen view, e.g. black-and-white only; the degree of contrast in the screen view; the screen frame rate, e.g. number of frames/sec; the degree of data compression (in percent) of the video coding formats or compression type; the resolution in the screen view, e.g., number of pixels; the degree or intensity of color in the screen view; and the degree of brightness in the screen view. For example, a black-and-white screen image takes less bandwidth than a color screen image; a low contrast screen image takes less bandwidth than a high contrast screen image; a low frame rate takes less bandwidth than a high frame rate; a high degree of data compression takes less bandwidth than a low degree of data compression; a low resolution screen image takes less bandwidth than a high resolution screen image; low color intensity in the screen view takes less bandwidth than high color intensity; and lower brightness in the screen view takes less bandwidth than higher brightness.

Even where high quality, high bandwidth video surveillance cameras are employed, other limitations prevent full accessibility of high quality images to clients. Clients may have multiple cameras and multiple users, and may require different levels of video quality for different users. Additionally, a client may require certain limitations on some of its users' access to the surveillance images. Further, all of the above considerations apply equally to images recorded on the system, and the clients' access to archived images.

Since video surveillance systems typically employ other local sensors such as motion detectors and door contacts (generally referred to as “input devices”) and local devices such as door and gate locks and floodlights(generally referred to as “output devices”), it would be useful to be able to integrate fully such sensors and devices into a video surveillance system. It would also be useful to be able to intelligently evaluate and notify the client of events at the clients' locations using more than the clients' local sensors.

Typical video surveillance systems are stand alone systems that are difficult to integrate with controls and do not provide to client users visibility to events in the entire system.

### SUMMARY OF THE INVENTION

Bearing in mind the problems and deficiencies of the prior art, it is therefore an object of the present invention to provide an improved video surveillance system and method that is able to create and manage multiple video streams at different compression types and different video quality parameters.

It is another object of the present invention to provide a video surveillance system and method of controlling a video surveillance system that permits clients to access simultaneously different levels of video quality for different users, for both live and recorded images.

It is a further object of the present invention to provide a video surveillance system and method of controlling a video surveillance system that permits multiple client users to access simultaneously and independently both live and recorded images in numbers and at video quality levels beyond those created by the video camera output.

Another object of the invention is to provide a video surveillance system and method that integrates control with decision-making logic over local sensors and devices at the clients' locations.

A further object of the invention is to provide a video surveillance system and method that delivers automated multimedia notification to the users based on evaluation of multiple inputs.

It is yet another object of the present invention to provide a video surveillance system and method that can track all events in the system and deliver information regarding selected events to any client user. Another object of the present invention is to provide a video surveillance system that is compliant with SCADA and other OPC software.

Still other objects and advantages of the invention will in part be obvious and will in part be apparent from the specification.

The above and other objects, which will be apparent to those skilled in the art, are achieved in the present invention which is directed to a method of controlling and distributing video signals from at least one video sensor to multiple video clients comprising providing at least one video sensor capable of receiving video input and sending an original video signal stream output based on the video input, and receiving a single original video signal stream from the at least one video sensor and converting the single original video signal stream into a plurality of video streams, with each video stream having a different video quality parameter. The method then includes identifying for each video client the video quality parameter to which it is entitled to access, and simultaneously sending each of the plurality of converted video streams to a plurality of different video clients, with each client receiving the video stream with a different video quality parameter to which it is entitled to access.

Preferably, the method includes providing a plurality of video sensors, the video sensors comprising video cameras, and identifying for each video client the video camera to which it is entitled to access; and wherein each client receives the converted video stream from the video camera to which it is entitled to access.

In another aspect, the present invention is directed to a method of controlling and distributing video signals from a video sensor to a video client comprising providing a video sensor capable of receiving video input and sending an original video signal stream output based on the video input, and identifying for a video client a video quality parameter to which it is entitled to access. The method further includes receiving a single original video signal stream from the video sensor and converting the single original video signal stream into a video stream having the video quality parameter to which the video client is entitled to access. The converted video stream has a video quality parameter different than the original video signal stream. The method then includes sending to the video client the converted video stream to which it is entitled to access.

The method may further include simultaneously recording a plurality of the converted video streams, each with a different video quality parameter. The method preferably includes providing a plurality of video sensors, the video sensors comprising video cameras, and identifying for the video client the video camera to which it is entitled to access.

The single original video signal stream from the video sensor may be simultaneously converted into the plurality of video streams. The different quality parameters may be different resolutions, degrees of compression, different frame rates, presence or absence of colors, intensity of colors, different contrast levels and different brightness levels. The method may further including simultaneously recording a plurality of the converted video streams, each with a different video quality parameter.

The single original video stream may be provided in a single compression algorithm, and the single original video signal stream may be simultaneously sent to at least one of the users.

Preferably, the converting of the single original video stream is performed by a controller, separate from the video sensor, capable of receiving a single original video signal stream from the video sensor and converting the single original video signal stream into a plurality of video streams, each video stream having a different video quality parameter.

The present invention is directed in a further aspect to a method of controlling and distributing video signals from a video sensor to at least one video client comprising providing a video sensor capable of receiving video input and sending an original video signal stream output based on the video input and providing a controller capable of receiving a single original video signal stream from the video sensor and converting the single original video signal stream into a plurality of video streams, with each video stream having a different video quality parameter. The method then includes identifying for each video client the video quality parameter to which it is entitled to access, receiving a request from a video client for a video signal stream having a video quality parameter different from the original video signal stream, and determining whether the video client is entitled to receive a video signal stream with the requested video quality parameter. If the video client is entitled to receive the video signal stream with the requested video quality parameter, the method includes sending to the video client the converted video signal stream with the requested video quality parameter.

The method may include receiving requests from multiple video clients for a video signal stream having a video quality parameter different from the original video signal stream, and includes determining whether the video clients are entitled to receive a video signal stream with the requested video quality parameter. If the video clients are entitled to receive the video signal stream with the requested video quality parameter, the method then includes simultaneously sending to the video clients the video signal stream with the requested video quality parameter.

Preferably, the single original video signal stream from the video sensor is simultaneously converted into the plurality of video streams. The method may further include simultaneously recording a plurality of the converted video streams, each with a different video quality parameter. There may be provided a plurality of video sensors comprising video cameras, and the method may include identifying for the video client the video camera to which it is entitled to access.

In yet another aspect, the present invention provides a system for controlling and distributing video signals from a video sensor to multiple video clients comprising a plurality of video sensor capable of receiving video input and sending an original video signal stream output based on the video input, a controller capable of receiving a single original video signal stream from the video sensor and converting the single original video signal stream into a plurality of video streams, with each video stream having a different video quality parameter, and a plurality of video clients, the video client having access to converted video streams having different video quality parameters. The controller is further capable of receiving requests from the video clients for video signal streams having a video quality parameter different from the original video signal stream of a video sensor, determining whether the video clients are entitled to receive a video signal stream with the requested video quality parameter, and simultaneously sending each of the plurality of converted video streams to a plurality of different video clients, with each client receiving the video stream with a different video quality parameter to which it is entitled to access. The system may further include a video recorder capable of simultaneously recording a plurality of the converted video streams, each with a different video quality parameter.

In another aspect the present invention is directed to a method of controlling a video surveillance system used by at least one video client comprising providing a plurality of video sensors capable of receiving video input, a motion in communication with the video sensors for determining motion in the video input, a scheduler for determining time of operation of the video sensors, a process controller link for determining status of components of the video surveillance system, and an automation controller, separate from the video sensors, capable of receiving multiple inputs and controlling operation of the video system. There are also provided multiple inputs to the automation controller, including inputs from the motion detector, inputs from the scheduler and inputs from the process controller. The method then includes evaluating multiple ones of the inputs, and sending an output signal to the video client or to control the video system based on evaluation of the multiple inputs.

In a related aspect the present invention is directed to a system for controlling a video surveillance system used by at least one video client comprising a plurality of video sensors capable of receiving video input, a motion in communication with the video sensors for determining motion in the video input, a scheduler for determining time of operation of the video sensors, a process controller link for determining status of components of the video surveillance system, and an automation controller, separate from the video sensors, capable of receiving multiple inputs. The inputs include inputs from the motion detector, inputs from the scheduler and inputs from the process controller. The automation controller is also capable of controlling operation of the video system by evaluating multiple ones of the inputs and sending an output signal to the video client or to control the video system based on evaluation of the multiple inputs.

The inputs may include time parameters. The output signal may be a notification to the video client of an event, a control signal to at least one video sensor, or a control signal to at least one device at a client location. The video surveillance system preferably includes a recorder for recording video signal stream output from the video sensors, and the output signal may be a control signal to the recorder. The motion detector may comprise a sensor at the video sensor or software at the recorder.

A further aspect of the invention is directed to a method of controlling and distributing video signals from at least one video sensor comprising providing at least one video sensor capable of receiving video input and sending a video signal stream output, based on the video input, at a predetermined maximum data transmission rate, and providing a video transmission path having a maximum data transmission rate lower than that of the video sensor. The method includes receiving a video input at the video sensor over a time period, storing the video signal stream output, based on the video input, at the predetermined maximum data transmission rate, and transmitting over the video transmission path the stored video signal stream output at a data transmission rate not exceeding the maximum data transmission rate of the video transmission path, the time for transmission being longer than the time period.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a schematic showing the major components and their interactive communication in operation of the present invention.

### DESCRIPTION OF THE PREFERRED EMBODIMENT(S)

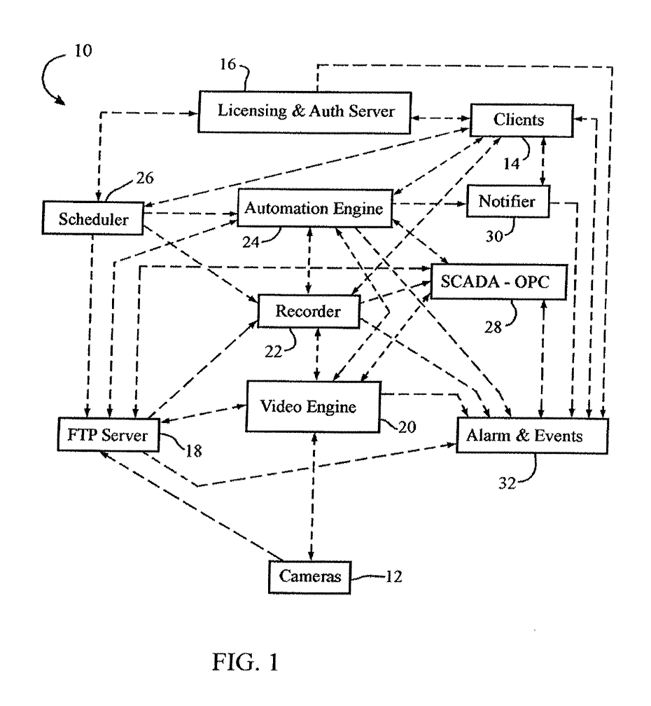

In describing the preferred embodiment of the present invention, reference will be made herein to FIG. 1 of the drawings in which like numerals refer to like features of the invention.

The present invention provides a Network Video Recorder (NVR) system that manages and controls many surveillance cameras with multiple users. The NVR system records multiple cameras simultaneously while managing concurrent users giving them access to real-time and archived video from anywhere on their internal network (LAN), across their wide area network (WAN) and/or over the Internet.

As shown in FIG. 1, the preferred Network Video Recorder (NVR) system 10 of the present invention consists of a number of functional controllers, servers, components or modules (also referred to as “engines”) that may be stand-alone and individually programmed or may be integrated into a general or special purpose computer system. The modules include Licensing and Authentication Server 16, Fast Transfer Protocol (FTP) Server 18, Video Engine 20, Video Recording Engine 22, Automation Engine 24, Scheduler Module 26, Supervisory Control and Data Acquisition (SCADA) Link 28, Notifier Module 30 and Alarm and Event Engine 32, all of which will be described in more detail below. Communication and transmission connections between the individual system 10 components, as well as with the video sensors 12 and clients 14, may be made by wireless, wireline, optical fiber cable, radio frequency (RF) or the like, and may also be made via an internal network (LAN), wide area network (WAN) and/or over the Internet or other connection means. Preferably the individual system 10 components other than video sensors 12 and clients 14, are incorporated as hardware or software modules within a computer, Communication and transmission connections that permit a higher data transmission rate are preferred.

The clients 14 using the system of the present invention log in through Licensing and Authentication Server 16 using otherwise conventional usernames and passwords. Each client may have one or more users and is licensed to access a predetermined number of cameras 12 via a predetermined number of concurrent client users. The clients may optionally be licensed to access the SCADA Link (described further below) parameters, either not visible (i.e., disabled) or visible (i.e., enabled) for further control and operational data of the system. The basic client access and control limitations are stored for access by the Licensing and Authentication Server. Scheduler Module 26 contains further data identifying limits of the client's access, e.g., hours of access, time limitations and the like, and other scheduling data such as the time the video sensors are to start and stop, and what type of recording is scheduled (e.g., constant, motion-triggered, and the like). The Scheduler Module communicates such information on the client's permitted access to the Licensing and Authentication Server. Based on the input requests from the Client 14 and the stored client access and control parameters, including those on the Scheduler Module 26, Licensing and Authentication Server 16 then determines whether the client user is permitted to access the system in the requested manner, according to the license. For example, the client user may be able to access real-time or archived recorded views from the cameras, effect pan, tilt, zoom (PTZ) or other positioning control of the cameras, or may be able to change passwords. Additionally, the individual client users may have predetermined restrictions on or permission to effect control of some or all of the camera functions, e.g., user 1 may have full viewing and control rights to all cameras, user 2 may have limited view and control access to cameras 1, 2 and 3 only, with rights to pan, tilt and zoom camera 1 only and rights to adjust the screen frame rate only, and user 3 may have only viewing and no control access to all cameras.

To enable the permitted access, Licensing and Authentication Server 16 then communicates the client view and control requests to the desired system components, such as Video Engine 20, SCADA Link 28 and Alarm and Event Engine 32. A record of all activity by each client is also sent by the Licensing and Authentication Server to Alarm and Event Server 32, such as login and log out events, failed login events, password change events, and requests that exceed the permitted licensed activities. Once a client is authenticated by Licensing and Authentication Server 16, the client may be directly linked in communication with the other system modules, such as Recorder 22, Automation Engine 24, Scheduler 26, Notifier 30 and Alarms and Events Engine 32.

System 10 uses one or more surveillance video cameras or other video sensors 12 to supply images of the scene of interest being monitored. The video sensor capable of receiving input of a visual image and converting it to an electronic signal is preferably a video camera that outputs moving images, but may be any other video sensor including, without limitation, still cameras. Audio inputs from the scene are optionally included with the video signal. The video sensor may also include other input devices or local sensors such as motion detectors, sound detectors, microphones, door contacts, light beams, push buttons and the like. Signals from such other local sensors may turn the video sensor on or off or otherwise exert limited local control, or such signals may be exported along with the video sensor output image signal.

Also, there may be communication with the NVR system 10 to output devices at the video sensor locations, such as door or gate locks, lights or other output devices. Upon sensing predetermined events via the video sensors, the NVR system may send commands to open or unlock doors or gates, or turn on lights at the video sensor location.

The video sensor signals are sent to FTP server 18 and simultaneously to Video Engine 20. Video Engine 20 may also receive any other input sensor signals. FTP server 18 is a an alternative method of transmitting video, and its function is to store video at the video sensor and to push video clips consisting of several video frames up to the video FTP server 18. The FTP process is triggered by an input event at the video sensor, at which time the video sensor pushes the video stream to Video Engine 20 via Server 18 instead of the Video Engine requesting an pulling it directly. This may be used where a camera connection has a very low data transmission rate or bandwidth (e.g., via radio frequency communication) and the camera is normally idling and not transmitting anything. If a sensor at the camera is triggered, e.g., motion is sensed at the camera site by a sensor, the camera pushes the video to the Video Engine through FTP protocol via Server 18. The bandwidth capability is increased because the camera stores the video locally at, for example, 5 frames per second, but then delivers it over a the RF communication link that is normally capable of only 1 frame per second. This transmission requires a longer time period of delivery where, for example, 12 seconds of video takes 60 seconds to deliver. The FTP server may notify the Recording Engine and the Alarm and Event Server when new data is uploaded from a video sensor. Additionally, the FTP Server receives data from the SCADA Link, Automation Engine and Scheduler Module, and sends data to SCADA Link and Alarm and Event Engine, such as video sensor login and log outs

Video Engine 20 pulls and/or receives a video stream from a video sensor at the compression and quality supplied by the video sensor, and converts it to one or more video streams at different compression types and different video quality parameters. As used herein, the term “video quality parameter” refers to a) the presence or absence of color in the screen view, e.g. black and white only (“color presence”); b) the degree of contrast in the screen view (“contrast”); c) the screen frame rate, e.g. number of frames/sec (“frame rate”); d) the degree of data compression (in percent) of the video coding formats or compression type (“percent compression”); e) the resolution in the screen view, e.g., number of pixels (“resolution”); f) the degree or intensity of color in the screen view (“color intensity”); and g) the degree of brightness in the screen view (“brightness”). The Video Engine then manages, buffers and delivers multiple video streams of the images from the video sensors out to one or more client users.

The SCADA (Supervisory Control and Data Acquisition) Link 28 is a process controller or communications link that passes data from NVR system 10 to an otherwise conventional, well known outside SCADA system. It acts as an OPC (object linking for process control) server providing information to other OPC-compliant system components

In addition to receiving queries from the Licensing and Authentication Server, the Scheduler Module sends information to the Recording Engine regarding the time the video sensors of a particular client are scheduled to start and stop recording, informs the Automation Engine when camera tours are scheduled to stop and start or when other system components are called upon to do anything in response to events and alarms throughout the system.

The operation of the system components can now be described in more detail. The Video Engine preferably supports all major camera output compression types such as MJPEG, H.264 and MPEG that are received as original video signal stream from the video sensors. The video signal streams are converted and independently sent to the clients at different video quality parameters or different compression types from those originally supplied by the video sensors 12. The Video Engine may convert any of the aforementioned input compression types (MPEG, MJPEG, H.264, and the like) to any of the aforementioned different video quality parameters.

The Video Engine filters and pre-screens requests for different compression types available from video device (e.g., MJPEG, MPEG, H.264), before any conversion to a different video quality parameter takes place. This reduces bandwidth, since it limits the requested video compression streams from the camera. Each client user may request a particular video quality parameter or combination of video quality parameters, which request is received by Licensing and Authentication Server 16. Video Engine 20 converts the original video signal into the different video streams with the requested video quality parameters as authorized by the Licensing and Authentication Server, and sends the different converted signals out simultaneously to the requesting client users. The Video Engine also groups client requests for the different video compression types and different video quality parameters from the camera.

Each change in video quality parameter potentially increases or decreases the bandwidth necessary for transmission of the converted signal to the client user. Required bandwidth is decreased by reducing color presence to black and white only, reducing contrast, reducing the screen frame rate, increasing the percent compression, decreasing the resolution, decreasing the color intensity, and decreasing brightness. Conversely, the required transmission bandwidth is increased by increasing color presence, contrast, screen frame rate, resolution, color intensity, and brightness, and reducing the percent compression. The Video Engine conversion to the different video quality parameters enables management of bandwidth to the different individual video clients to permit the requested video quality parameter to be sent to the individual client user. The Video Engine may modify video quality parameters other than the one requested by the client user to accommodate the bandwidth available for transmission of the converted signal to the user. For example, the Video Engine may increase compression (which reduces required bandwidth) while increasing frames/sec (which increases required bandwidth). Video Engine 20 effects any combination of change in video quality parameter, depending on the bandwidth available, to send the requested signal to the individual client users. Each user at a client may independently receive different video quality parameters. This enables one to go beyond the limitations of the video cameras to serve up the signal to many more clients with different video quality parameters.

The capability to create multiple video quality parameters by the Video Engine in the present system has the advantages of extending the capabilities of the video sensor (e.g., creating 5000 streams of image output versus the five available from the camera), and reducing the bandwidth required in the communication link from the video sensors, since the conversions take place after the video sensors feed to the Video Engine.

Commands and requests to be effected by the other system components are passed through by the Video Engine. For example, commands for pan, tilt, zoom or other positioning control from the client users or from the SCADA Link or Automation or Recording Engines are passed through to the video sensors. Inputs from the video sensors and other system components are also passed through the Video Engine, e.g., the SCADA Link may read inputs from the cameras for updating OPC tags.

Any of the converted video signals may be sent alternately or simultaneously to the Recording Engine 22 to be stored and archived for later retrieval by the client users. Recording Engine 22 may also send stored video signals to the Video Engine to be further converted to any of the different video quality parameters, and then transmitted to the requesting client user or stored again on the Recording Engine.

The Alarm and Event Server receives data of all activities of the Video Engine, such as camera health status and alarms (e.g., connection errors, signal losses, signal recoveries and the like), camera input alarms, camera output control information (e.g., output successfully changed or failed to change), camera pan, tilt, zoom (PTZ) or other preset positioning or configuration information (e.g., “NW Corner preset was created on “Camera 1” by [user]), or camera movement events (e.g., “Camera 1” was moved to [Preset or Coordinate], requested by [user, Recording Engine, Automation Engine, etc.]).

Recording Engine 22 records and stores the altered and converted video signal from the Video Engine, along with the original video signal stream from the video sensors. (Alarm and Events Module 32 can record inputs from the local input devices, e.g., motion sensors wired into the video sensors, inputs from Automation Engine 24; inputs from SCADA Link 28; inputs or triggers from Scheduler 26.) Recording Engine 22 records in multiple formats at the different compression types and video quality parameters supplied to it. Preferably, the Recording Engine encodes the recorded video signal into a proprietary and secure format viewable only by the system, and stored and secured in an archive on computer readable storage medium in the system.

Any FTP video signals pushed from the video sensors to the FTP Server are also received at the Recording Engine, which monitors and detects when new images are provided along with the particular originating video sensor, and records them as before.

Inputs to the Recording Engine determine whether recording is constant over a defined time period or is triggered by events (indicated by local sensors, the Recording engine itself, or other system components). Recording Engine inputs may also cause it to request the Video Engine to move the video sensors to specified PTZ coordinates or defined presets in preparation for recording.

Preferably, Recording Engine 22 also includes software-based motion detection capabilities beyond those of the local sensors at the video sensor locations. It may receive an input from the Scheduler 26 to determine if motion detection should be enabled for the incoming video signal streams. If so, it requests video signal streams from the Video Engine or other input and, by comparing the images on the frames at user-defined sampling rate and sensitivity, determines if motion is present. If motion is sensed by the Recording Engine, it sends a signal to Automation Engine 24 indicating that motion has been detected on a particular video sensor stream. Such motion detection may then be encoded with suitable tags in a constant recording for search and replay, or may trigger commencement of recording by the Recording Engine.

Stored and archived video on the Recording Engine is monitored for status and health by path and device, including connection, free space, authentication and the like. The number of days for each video to be stored is predefined by the user, per camera, and this input is used to determine what outdated video data is to be erased. For resource planning, the recording Engine also tracks and reports statistics for each video sensor of average file size and other relevant parameters.

All relevant activities of the Recording Engine are sent to the Alarm and Event Server, such as motion alarms, start and/or stop recording evens, FTP image events, available space information and errors received from archived path or device.

The Automation Engine 24 manages the inputs and outputs available on the video sensors. This allows for device integration into the NVR system through the sensor inputs, such as door contacts, motion sensors, light beams, and the like. The Automation Engine has the capability to make decisions based on inputs from the other system components, such as the Video Engine, the SCADA Link or the Scheduler. The commands are then sent on the various system components, such as the Video Engine, the SCADA Link, the Recording Engine, the Alarm and Event Engine, or the Notifier. For example, the command or decision may be to 1) send to the Video Engine an output control request on one or more cameras to turns on lights or the like; 2) raise alarms in the SCADA Link; 3) send start/stop camera touring requests to the video sensors; 4) send start/stop recording requests to the Recording Engine; 5) send requests for changes to any of the video quality parameters being recording to the Recording Engine; or 6) send multimedia notifications by emails, sound and the like to the Notifier.

The inputs for these Automation Engine decisions may be based on: a) input from the Scheduler to determine whether any particular events should trigger the requests or alarms; b) input from the cameras to trigger the requests or alarms; c) events from the SCADA Link to trigger the requests or alarms; d) motion events from the SCADA Link to trigger the requests or alarms; or e) scheduled events from the Scheduler to trigger the requests or alarms. One or more of these inputs may result in one or more of the aforedescribed commands or decisions by the Automation Engine. In other words, any of inputs (a)-(e) may cause command or decision (1)-(6).

SCADA Link 28 passes live information to and receives live information from the other system components. It may receive general video sensor information (e.g., camera name, IP address, port used) from the Video Engine, Video sensor status and health information from the Automation Engine, including tour status information on video sensors (e.g., active, non-active, name of active tour), video sensor recording status from the Recording Engine, and applicable alarms and events from the Alarm and Event Engine. It may pass video sensor output control requests to the Automation Engine, start/stop tour requests to the Automation Engine, change recording quality to the Recording Engine, and alarm and event information to the Alarm and Event Engine.

The NVR system may be used to notify the client users of alarms or events detected by the system or local sensors. Notifier Module 30 receives data from the Automation Engine to send multimedia notifications to the client, for example by email or by remote audio or visual devices located at the client's premises. Any such notifications are reported to the Alarm and Event Server, whether successful or unsuccessful, along with the trigger data received from the Automation Engine. In use, the Automation Engine controls operation of the NVR system by receiving multiple inputs, including inputs from the motion detector, inputs from the scheduler and inputs from the process controller. The motion detector input may be hardware-based, from the local video sensors, or may be software-based, from the Recording Engine. The Automation Engine then evaluates the multiple inputs and directs the Notifier Module to sends an output notification signal to the client of an event. Alternately, or in addition to the client notification, the Automation Engine may make further changes to other system parameters to control the NVR system based on evaluation of the multiple inputs. For example, the Automation Engine may send a control signal to one or more video sensors to start or change operation or touring, to change converted video quality parameter of video signal(s), or to open or unlock doors, turn on lights or operate other devices at the client location, or the Automation Engine may send a control signal to the Recording Engine to start recording.

The NVR additionally permits addition of algorithms for analytics such as auto PTZ tracking, people counters, vehicle counters, suspicious object left behind, loitering, etc.

The present invention may be embodied as a system, method or computer program product. The present invention, other than the video sensors, may take the form of an entirely hardware embodiment, an entirely software embodiment (including firmware, resident software, micro-code, etc.) or an embodiment combining software and hardware aspects that may all generally be referred to herein as a “circuit,” “module” or “system.” The present invention may take the form of a computer program product embodied in one or more computer readable medium(s) having computer readable program code embodied thereon.

One or more computer readable medium(s) may be utilized, alone or in combination. A suitable computer readable storage medium may be, for example, but not limited to, an electronic, magnetic, optical, electromagnetic, infrared, or semiconductor system, apparatus, or device, or any suitable combination of the foregoing. Other examples of suitable computer readable storage medium would include, without limitation, the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. A suitable computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, radio frequency (RF) or the like, or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to diagrams of function blocks or modules in drawing FIG. 1 showing methods, apparatus (systems) and computer program products according to embodiments of the invention. It will be understood that each block and combinations of blocks in the drawings can be implemented by computer program instructions, preferably written in Microsoft.NET available from Microsoft Corporation, Redmond, Wash. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the function blocks or modules in drawing FIG. 1.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the function blocks or modules in drawing FIG. 1.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the function blocks or modules in drawing FIG. 1.

The function blocks or modules in drawing FIG. 1 illustrate the architecture, functionality, and operation of possible implementations of systems, methods and computer program products according to various embodiments of the present invention. In this regard, each block in the drawing may represent a module, segment, or portion of code, which comprises one or more executable instructions for implementing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order, depending upon the functionality involved. It will also be noted that each block and combinations of blocks in the drawing can be implemented by special purpose hardware-based systems that perform the specified functions or acts, or combinations of special purpose hardware and computer instructions. Also, although communication between function blocks or modules may be indicated in one direction on the drawing, such communication may also be in both directions.

Thus, the present invention provides an improved video surveillance system and method that is able to create and manage multiple video streams at different compression types and different video quality parameters. It permits multiple client users to access simultaneously and independently both live and recorded images in numbers and at video quality levels beyond those created by the video camera output. The video surveillance system integrates control with decision-making logic over local sensors and devices at the clients' locations, delivers information regarding selected events to any client user, and delivers automated multimedia notification to the users based on evaluation of multiple inputs. The system is compliant with SCADA and other OPC software.

While the present invention has been particularly described, in conjunction with a specific preferred embodiment, it is evident that many alternatives, modifications and variations will be apparent to those skilled in the art in light of the foregoing description. For example, the NVR system of the present invention may be set up to handle one dedicated client with its own video and local sensors, or may be set up to handle a plurality of different clients and their respective video and local sensors. It is therefore contemplated that the appended claims will embrace any such alternatives, modifications and variations as falling within the true scope and spirit of the present invention.

Thus, having described the invention,

What is claimed is:

1. A method of controlling and distributing video signals from at least one video sensor to multiple video clients comprising:
providing at least one video sensor capable of receiving video input and sending an original video signal stream output based on the video input;
receiving a single original video signal stream from the at least one video sensor and converting the single original video signal stream into a plurality of video streams, each video stream having a different video quality parameter;
identifying for each video client the video quality parameter to which it is entitled to access; and
simultaneously sending each of the plurality of converted video streams to a plurality of different video clients, each client receiving the video stream with a different video quality parameter to which it is entitled to access.

2. The method of claim 1 wherein the single original video signal stream from the video sensor is simultaneously converted into the plurality of video streams.

3. The method of claim 1 wherein the different quality parameters are different resolutions.

4. The method of claim 1 wherein the different quality parameters are different degrees of compression.

5. The method of claim 1 wherein the different quality parameters are different frame rates.

6. The method of claim 1 wherein the different quality parameters are the presence or absence of colors.

7. The method of claim 1 wherein the different quality parameters are different intensity of colors.

8. The method of claim 1 wherein the different quality parameters are different levels of contrast.

9. The method of claim 1 wherein the different quality parameters are different levels of brightness.

10. The method of claim 1 wherein the different quality parameters are selected from the group consisting of different resolutions, degrees of compression, different frame rates, presence or absence of colors, intensity of colors, different contrast levels and different brightness levels.

11. The method of claim 1 further including simultaneously recording a plurality of the converted video streams, each with a different video quality parameter.

12. The method of claim 1 including simultaneously sending the single original video signal stream to at least one user.

13. The method of claim 1 wherein the single original video stream is provided in a single compression algorithm.

14. The method of claim 1 wherein the converting of the single original video stream is by a controller, separate from the video sensor, capable of receiving a single original video signal stream from the video sensor and converting the single original video signal stream into a plurality of video streams, each video stream having a different video quality parameter.

15. The method of claim 1 including providing a plurality of video sensors, the video sensors comprising video cameras, and identifying for each video client the video camera to which it is entitled to access; and wherein each client receives the converted video stream from the video camera to which it is entitled to access.

16. A method of controlling and distributing video signals from a video sensor to a video client comprising:
providing a video sensor capable of receiving video input and sending an original video signal stream output based on the video input;
identifying for a video client a video quality parameter to which it is entitled to access;
receiving a single original video signal stream from the video sensor and converting the single original video signal stream into a video stream having the video quality parameter to which the video client is entitled to access, the converted video stream having a video quality parameter different than the original video signal stream; and
sending to the video client the converted video stream to which it is entitled to access.

17. The method of claim 16 wherein the single original video signal stream from the video sensor is simultaneously converted into the plurality of video streams.

18. The method of claim 16 wherein the different quality parameters are selected from the group consisting of different resolutions, degrees of compression, different frame rates, presence or absence of colors, intensity of colors, different contrast levels and different brightness levels.

19. The method of claim 16 further including simultaneously recording a plurality of the converted video streams, each with a different video quality parameter.

20. The method of claim 16 wherein the single original video stream is provided in a single compression algorithm.

21. The method of claim 16 wherein the converting of the single original video stream is by a controller, separate from the video sensor, capable of receiving a single original video signal stream from the video sensor and converting the single original video signal stream into the converted video stream to which the video client is entitled to access.

22. The method of claim 16 including providing a plurality of video sensors, the video sensors comprising video cameras, and identifying for the video client the video camera to which it is entitled to access.

23. A method of controlling and distributing video signals from a video sensor to at least one video client comprising:
providing a video sensor capable of receiving video input and sending an original video signal stream output based on the video input;
providing a controller capable of receiving a single original video signal stream from the video sensor and converting the single original video signal stream into a plurality of video streams, each video stream having a different video quality parameter;
identifying for each video client the video quality parameter to which it is entitled to access;
receiving a request from a video client for a video signal stream having a video quality parameter different from the original video signal stream;
determining whether the video client is entitled to receive a video signal stream with the requested video quality parameter; and
if the video client is entitled to receive the video signal stream with the requested video quality parameter, sending to the video client the converted video signal stream with the requested video quality parameter.

24. The method of claim 23 wherein requests are received from multiple video clients for a video signal stream having a video quality parameter different from the original video signal stream, and including determining whether the video clients are entitled to receive a video signal stream with the requested video quality parameter, and, if the video clients are entitled to receive the video signal stream with the requested video quality parameter, simultaneously sending to the video clients the video signal stream with the requested video quality parameter.

25. The method of claim 23 wherein the single original video signal stream from the video sensor is simultaneously converted into the plurality of video streams.

26. The method of claim 23 wherein the different quality parameters are selected from the group consisting of different resolutions, degrees of compression, different frame rates, presence or absence of colors, intensity of colors, different contrast levels and different brightness levels.

27. The method of claim 23 further including simultaneously recording a plurality of the converted video streams, each with a different video quality parameter.

28. The method of claim 23 including providing a plurality of video sensors, the video sensors comprising video cameras, and identifying for the video client the video camera to which it is entitled to access.

29. A system for controlling and distributing video signals from a video sensor to multiple video clients comprising:
a plurality of video sensor capable of receiving video input and sending an original video signal stream output based on the video input;
a controller capable of receiving a single original video signal stream from the video sensor and converting the single original video signal stream into a plurality of video streams, each video stream having a different video quality parameter; and
a plurality of video clients, the video client having access to converted video streams having different video quality parameters,
the controller further being capable of receiving requests from the video clients for video signal streams having a video quality parameter different from the original video signal stream of a video sensor, determining whether the video clients are entitled to receive a video signal stream with the requested video quality parameter, and simultaneously sending each of the plurality of converted video streams to a plurality of different video clients, each client receiving the video stream with a different video quality parameter to which it is entitled to access.

30. The system of claim 29 further including a video recorder capable of simultaneously recording a plurality of the converted video streams, each with a different video quality parameter.

31. The system of claim 29 wherein the different quality parameters are selected from the group consisting of different resolutions, degrees of compression, different frame rates, presence or absence of colors, intensity of colors, different contrast levels and different brightness levels.

32. A method of controlling a video surveillance system used by at least one video client comprising:
providing a plurality of video sensors capable of receiving video input;
providing a motion detector in communication with the video sensors for determining motion in the video input;
providing a scheduler for determining time of operation of the video sensors;
providing a process controller link for determining status of components of the video surveillance system;
providing an automation controller, separate from the video sensors, capable of receiving multiple inputs and controlling operation of the video system;
providing multiple inputs to the automation controller, including inputs from the motion detector, inputs from the scheduler and inputs from the process controller;
evaluating multiple ones of the inputs; and
sending an output signal to the video client or to control the video system based on evaluation of the multiple inputs.

33. The method of claim 32 wherein the output signal is a notification to the video client of an event.

34. The method of claim 32 wherein the output signal is a control signal to at least one video sensor.

35. The method of claim 32 wherein the output signal is a control signal to at least one device at a client location.

36. The method of claim 32 wherein the video surveillance system includes a recorder for recording video signal stream output from the video sensors and wherein the output signal is a control signal to the recorder.

37. The method of claim 32 wherein the inputs include time parameters.

38. The method of claim 32 wherein the motion detector comprises software at the recorder.

39. The method of claim 32 wherein the motion detector comprises a sensor at the video sensor.

40. A system for controlling a video surveillance system used by at least one video client comprising:
a plurality of video sensors capable of receiving video input;
a motion detector in communication with the video sensors for determining motion in the video input;
a scheduler for determining time of operation of the video sensors;
a process controller link for determining status of components of the video surveillance system;
an automation controller, separate from the video sensors, capable of receiving multiple inputs, including inputs from the motion detector, inputs from the scheduler and inputs from the process controller, and controlling operation of the video system by evaluating multiple ones of the inputs and sending an output signal to the video client or to control the video system based on evaluation of the multiple inputs.

41. The system of claim 40 wherein the output signal is a notification to the video client of an event, a control signal to at least one video sensor, or a control signal to at least one device at a client location.

42. The system of claim 40 wherein the video surveillance system includes a recorder for recording video signal stream output from the video sensors and wherein the output signal is a control signal to the recorder.

43. The system of claim 40 wherein the motion detector comprises software at the recorder.

44. The system of claim 40 wherein the motion detector comprises a sensor at the client.

45. A method of controlling and distributing video signals from at least one video sensor comprising:
providing at least one video sensor capable of receiving video input and sending a video signal stream output, based on the video input, at a predetermined maximum data transmission rate;
providing a video transmission path having a maximum data transmission rate lower than that of the video sensor;
receiving a video input at the video sensor over a time period;
storing the video signal stream output, based on the video input, at said predetermined maximum data transmission rate;
transmitting over the video transmission path the stored video signal stream output at a data transmission rate not exceeding the maximum data transmission rate of the video transmission path, the time for transmission being longer than said time period.
